(19) United States
(12) Patent Application Publication
(10) Pub. No.: US 2022/0138668 A1
(43) Pub. Date: May 5, 2022

(54) ON-DEMAND TRANSPORTATION OF OBJECTS

(71) Applicant: Allserviceusa.com Inc., Bohemia, NY (US)

(72) Inventors: Robert Ingraselino, Coram, NY (US); Joseph Ingraselino, Bohemia, NY (US)

(21) Appl. No.: 17/188,543

(22) Filed: Mar. 1, 2021

Related U.S. Application Data
(60) Provisional application No. 63/109,569, filed on Nov. 4, 2020.

(51) Int. Cl. G06Q 10/08

(52) U.S. Cl. CPC G06Q 10/083

(57) ABSTRACT

Methods and systems for on-demand delivery are described. A processor can receive a request from a user interface to deliver an object from a first location to a second location. The processor can receive provider data from a server that includes information of multiple service providers. The processor can receive a selection of a service provider from the user interface. The processor can receive confirmation data from the server indicating the selected service provider accepted the request and a location of the selected service provider. The processor can pull real-time locations of the selected service provider periodically until the selected service provider is located at the first location.

### BACKGROUND

Unless otherwise indicated herein, the materials described in this section are not prior art to the claims in this application and are not admitted to be prior art by inclusion in this section.

On-demand transportation services for meal and grocery deliveries, and parcels, can be available via the Internet or mobile applications. These on-demand transportation services can identify service providers (e.g., vehicles) based on availability and location of the service providers.

### SUMMARY

Methods and systems for on-demand delivery are described. A processor can receive a request from a user interface to deliver an object from a first location to a second location. The processor can receive provider data from a server that includes information of multiple service providers. The processor can receive a selection of a service provider from the user interface. The processor can receive confirmation data from the server indicating the selected service provider accepted the request and a location of the selected service provider. The processor can pull real-time locations of the selected service provider periodically until the selected service provider is located at the first location.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

FIG. 1 is a diagram illustrating a system that can implement on-demand transportation of objects in one embodiment.

FIG. 2 is a diagram illustrating another system that can implement on-demand transportation of objects in one embodiment.

FIG. 3 is a diagram illustrating another system that can implement on-demand transportation of objects in one embodiment.

FIG. 4 is a diagram illustrating a process that can implement on-demand transportation of objects in one embodiment.

FIG. 5 is a diagram illustrating another process that can implement on-demand transportation of objects in one embodiment.

FIGS. 6A-6J are diagrams illustrating operations of a user interface that can be used to implement on-demand transportation of objects in one embodiment.

FIGS. 7A-7J are diagrams illustrating operations of another user interface that can be used to implement on-demand transportation of objects in one embodiment.

FIG. 8 is a diagram illustrating another process that can implement on-demand transportation of objects in one embodiment.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

In an example, users purchasing relatively large objects, such as furniture, may not possess a vehicle having the appropriate size to transport the large objects. The users may employ delivery services having vehicles of the appropriate size to transport or deliver the large objects. These delivery services may be provided by the seller entity selling the large objects, or by a third party employed by the seller entity. In some examples, the users may have limited choice in selecting a delivery service of their choice to deliver the large objects. On-demand parcel delivery services are typically tailored for delivery of relatively small parcels. Further, on-demand parcel delivery services typically do not provide a selection of service providers based on vehicle size and the amount of help (e.g., number of helpers to move the relatively large objects).

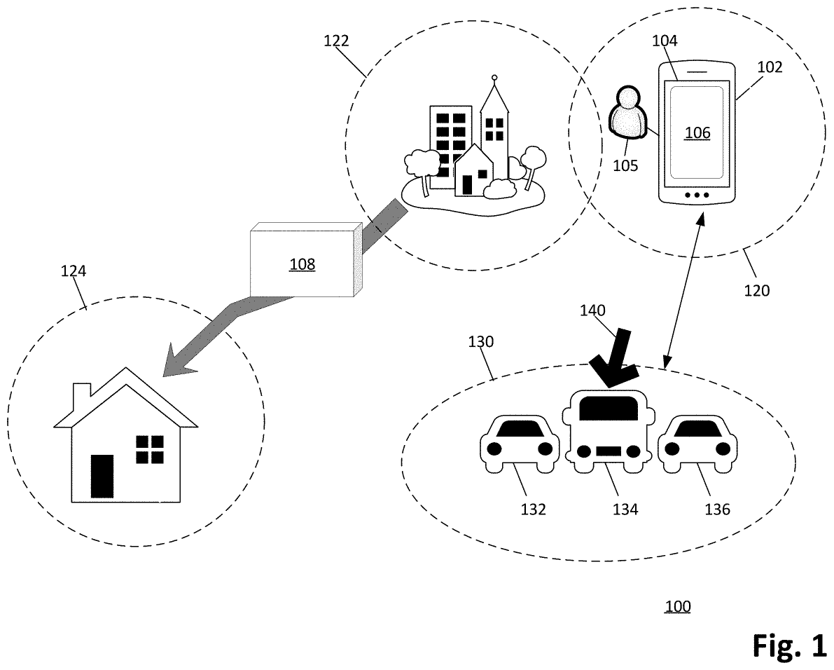

FIG. 1 is a diagram illustrating a system 100 that can implement on-demand transportation of objects in accordance with an embodiment of the present invention. The system 100 can be implemented by a device 102, where the device 102 can be, for example, a cellular phone, a smartphone, a desktop computer, a laptop computer, a tablet computer, a smartwatch, a wearable device, and/or other types of computing devices. The device 102 can include a screen or a display 104. In an example, the display 104 can be a touchscreen device configured to receive inputs from one or more users exerting pressure on the display 104. In some examples, the display 104 can be a display or screen coupled to the device 102 and the display 104 can be configured to receive inputs from input devices such as keyboard and computer mouse. In some examples, the display 104 can be a part of the device 102 (e.g., embedded in the device 102) or can be a separate component from the device 102. The device 102 can be configured to run an application to render and output a user interface 106 on the display 104.

In an example, a user 105 of the device 102 can use the user interface 106 to input a selection 140. The selection 140 can be a selection of a vehicle among a vehicle pool 130. In the example shown in FIG. 1, the selection 140 can indicate a selection of a vehicle 134 among the vehicle pool 130, where the vehicle pool 130 includes a plurality of vehicles such as vehicles 132, 134, 136. The vehicle pool 130 can include an arbitrary number of vehicles.

In another example, the user 105 of the device 102 can be in possession of an object 108, such as being an owner of the object 108 or being a purchaser of the object 108. The object 108 can be, for example, a piece of furniture, a parcel, a package, equipment (e.g. exercise, recreational, machines), a shed, and/or other types of objects that can be relatively large. The user 105 of the device 102 can demand a delivery or transportation of the object 108 from a first location 122 to a second location 124. In an example, the device 102 can be located in a location 120, where the location 120 can be same or different from the location 122 and/or the location 124. The user of the device 102 can browse the vehicle pool 130 using the user interface 106. In an example, the user interface 106 can display a size of each vehicle among the vehicle pool. The user 105 of the device 102 can make the selection 140 based on a size of the object 108 and/or the size of the vehicles among the vehicle pool 130. For example, the selection 140 can be based on the vehicle 134 having sufficient capacity to store the object 108.

To be described in more detail below, the vehicle pool 130 can include a plurality of categories to categorize the vehicles among the vehicle pool based on their size. Further, the vehicle pool 130 can be updated periodically or based on an on-demand approach. Furthermore, the device 102 can be configured to pull an updated version of the vehicle pool in response to the user 105 of the device 102 logging in to an application implementing the system 100. Still further, a server can be implemented with the system 100 to update the vehicle pool 130 and to push updated vehicles among the vehicle pool 130 to provide recommendations and promotions to the user 105 of the device 102. In another example, owners or operators of the vehicles among the vehicle pool can approve or reject the selection 140 made by the deice 102.

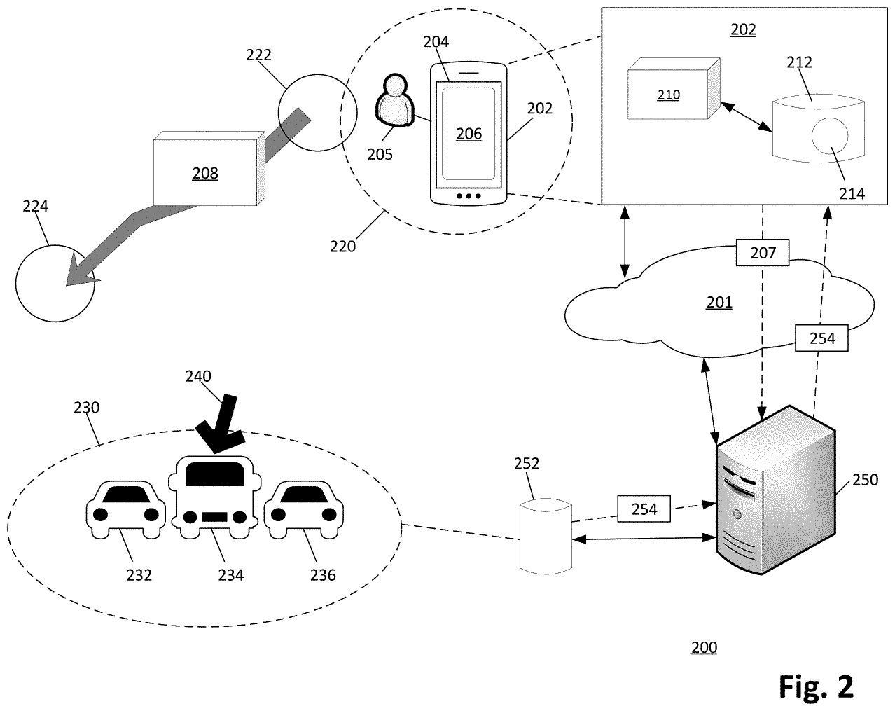

FIG. 2 is a diagram illustrating another system 200 that can implement on-demand transportation of objects in accordance with an embodiment of the present invention. The system 200 can be implemented by a device 202 and a server 250, where device 202 and the server 250 can be configured to be in communication with each other via a network 201. The device 202 can be, for example, a cellular phone, a smartphone, a desktop computer, a laptop computer, a tablet computer, a smartwatch, a wearable device, and/or other types of computing devices. The server 250 can be a server computer including a plurality of hardware processors and/or memory devices, and the server 250 can be located in a remote location from the device 202 such as a data center. The network 201 can be, for example, the Internet, a cellular network, a wireless network, and/or other types of wired or wireless networks that can facilitate transmission of data between the device 202 and the server 250.

The device 202 can include a screen or a display 204. In an example, the display 204 can be a touchscreen device configured to receive inputs from one or more users exerting pressure on the display 204. In some examples, the display 204 can be a display or screen coupled to the device 202 and the display 204 can be configured to receive inputs from input devices such as keyboard and computer mouse. In some examples, the display 204 can be a part of the device 202 (e.g., embedded in the device 202) or can be a separate component from the device 202. The device 202 can be configured to run an application to render and output a user interface 206 on the display 204.

In an example, the device 202 can include a processor 210 and a memory 212. The processor 210 can be configured to be in communication with the memory 212. The memory 212 can be a memory device among a plurality of memory devices embedded in the device 202 and/or the processor 210. The memory 212 can be configured to store an application 214, where the application 214 can be provided by the server 250. For example, the application 214 can be a mobile application and/or a computer application downloaded from the server 250 via the network 201. The application 214 can be an executable file and can include executable code that can be executed by the processor 210 according to an operating system being run by the processor 210 on the device 202. In an example, the server 250 can store the source code of the application 214. In an example, the execution of the application 214 can cause the user interface 206 to be rendered by the processor 210 and outputted by the processor 210 on the display 204.

In an example, a user 205 of the device 202 can be in possession of an object 208, such as being an owner of the object 208 or being a purchaser of the object 208. The object 208 can be, for example, a furniture, a parcel, a package, an equipment, and/or other types of objects that can be relatively large. The user 205 of the device 202 can demand a delivery or transportation of the object 208 from a first location 222 to a second location 224. In an example, the device 202 can be located in a location 220, where the location 220 can be same or different from the location 222 and/or the location 224. The user 205 of the device 202 can use the user interface 206 displayed on the display 204 to select a service provider to deliver or transport the object 208 from the location 222 to the location 224. In an example, the user interface 206 can display a plurality of service providers having a plurality of vehicles among a vehicle pool 230. The user 205 of the device 202 can select a service provider or a vehicle among the vehicle pool 230. In an example, a size of each vehicle among the vehicle pool 230 can be displayed on the user interface 206 to allow the user 205 to select a vehicle based on a size of the vehicles in the vehicle pool 230. For example, the user 205 can select a vehicle that has sufficient capacity to store the object 208. In an example, the vehicle pool 230 can include a plurality of vehicles, such as at least vehicles 232, 234, 236.

In an example, the vehicle pool 230 can be maintained by the server 250 as a database 252. The database 252 can be stored in a memory device of the server 250. The database 252 can include provider data, such as a plurality of attributes of a plurality of vehicles, such as their brand, model, make, model year, size category (e.g., compact, sedan, hatchback, minivan, van, pickup truck, truck, etc.). In some examples, the provider data can be presented in a map being displayed in the user interface 206 to show current locations of a plurality of available service providers. In an example, the device 202 can send a request 207 for a service provider or for a vehicle to the server 250. The server 250, in response to the receipt of the request 207, can extract a portion 254 of the database 252, where the portion 254 can include data on particular vehicles among the vehicle pool 230 that satisfy one or more criteria specified by the request 207 (e.g., available times, vehicle size, etc.). For example, the request 207 can specify a time frame to fulfill the request 207, the location 222, and the location 224, and the portion 254 can include vehicles that are available in the specified time frame and located within a particular distance from the location 222. Further, the request 207 can include a size of the object 208 and/or an attribute of the vehicle being requested. For example, the request 207 can include a request for a vehicle of a particular size, brand, model, color, type, etc. The server 250 can send the portion 254 to the device 202.

In response to receiving the portion 254, the processor 210 can execute a part of the application 214 to output the portion 254 of the database 252 on the user interface 206. For example, the processor 210 can execute particular lines of executable code among the application 214 to populate a portion of the user interface 206 with the data of the portion 254, such that the data of the portion 254 can be viewable to the user 205 on the user interface 206. The user 205 of the device 202 can view the displayed portion 254 and can use the user interface 206 to input a selection 240. The device 202 can send the selection 240 to the server 150. The selection 240 can be a selection of a vehicle among a vehicle pool 230 and among the portion 254. In the example shown in FIG. 2, the selection 240 can indicate a selection of a vehicle 234 among the vehicle pool 230. In response to receiving the selection 240 from the device 202, the server 250 can communicate with the service provider having possession of the selected vehicle 234 to fulfill the request 207.

In another example, the processor 210 of the device 202 can be configured to autonomously generate the request 207 in response to the application 214 being triggered by the device 202. For example, the user 205 can select the application 214 among a plurality of applications installed in the device 202. The processor 210 can detect the application 214 being selected and generate the request 207 to include at least a current location of the device 202 (e.g., location 220). The processor 210 can further append a message to the request 207 indicating that the request 207 is an autonomously generated request. The processor 210 can send the autonomously generated request 207 to the server 250. The server 250 can receive the autonomously generated request 207 and perform a prefetch (e.g., extraction of data before a user request) of the portion 254 from the database 252. The server 250 can store the extracted portion 254 in a memory of the server 250 until receiving another signal from the device 202 indicating a request for the extracted portion 254. For example, upon starting the application 214 on the device 202, the user 205 can input login credentials, and the processor 210 can generate a message or a new request in response to validating the login credentials. This message or new request can indicate that the user 205 has logged in to the application 214. The processor 210 can send this message or new request to the server 250. The server 250 can receive this message or new request and, in response, send the stored portion 254 to the device 202. By performing the prefetch of the portion 254, the system 200 can be implemented in a relatively efficient rate since the server 250 has the extracted portion 254 ready for transmission upon starting the application 214 on the device 202.

In another example, the user 205 can start the application 214 on the device 202, but exit or terminate the application 214 without inputting login credentials. The processor 210 can generate a message or a new request in response the application 214 being terminated, where this message or new request can indicate that the user 205 has exited the application 214 without logging in. The processor 210 can send this message or new request to the server 250. The server 250 can receive this message or new request and, in response, discard the stored portion 254.

In another example, the user 205 can start the application 214 on the device 202, but exit or terminate the application 214 without inputting login credentials. After a lapse of an amount of time (e.g., 30 seconds, 1 minute, 2 minutes, etc.) If the server 250 detects no further request from the device 202 indicating whether the user 205 has logged in or not, the server 250 can discard the stored portion 254.

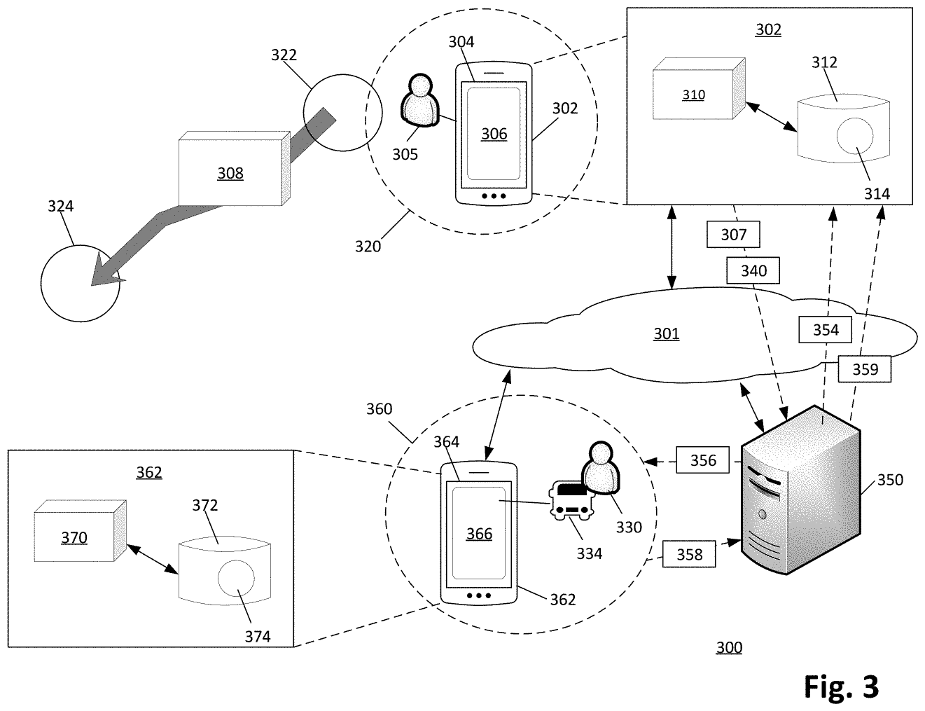

FIG. 3 is a diagram illustrating another system 300 that can implement on-demand transportation of objects in accordance with an embodiment of the present invention. The system 300 can be implemented by a device 302, a device 362, and a server 350, where device 302, the device 362, and the server 350 can be configured to be in communication with each other via a network 301. The devices 302 and 362 can each be, for example, a cellular phone, a smartphone, a desktop computer, a laptop computer, a tablet computer, a smartwatch, a wearable device, and/or other types of computing devices. The server 350 can be a server computer including a plurality of hardware processors and/or memory devices, and the server 350 can be located in a remote location from the device 302 such as a data center. The network 301 can be, for example, the Internet, a cellular network, a wireless network, and/or other types of wired or wireless networks that can facilitate transmission of data between the devices 302, 362, and the server 350.

The device 302 can include a screen or a display 304. In an example, the display 304 can be a touch screen device configured to receive inputs from one or more users exerting pressure on the display 304. In some examples, the display 304 can be a display or screen coupled to the device 302 and the display 304 can be configured to receive inputs from input devices such as keyboard and computer mouse. In some examples, the display 304 can be a part of the device 302 (e.g., embedded in the device 302) or can be a separate component from the device 302. The device 302 can be configured to run an application to render and output a user interface 306 on the display 304.

In an example, the device 302 can include a processor 310 and a memory 312. The processor 310 can be configured to be in communication with the memory 312. The memory 312 can be a memory device among a plurality of memory devices embedded in the device 302 and/or the processor 310. The memory 312 can be configured to store an application 374, where the application 374 can be provided by the server 350. For example, the application 374 can be a mobile application and/or a computer application downloaded from the server 350 via the network 301. The application 374 can be an executable file and can include executable code that can be executed by the processor 370 according to an operating system being run by the processor 370 on the device 362. In an example, the server 350 can store the source code of the application 374. In an example, the execution of the application 374 can cause the user interface 366 to be rendered by the processor 370 and outputted by the processor 370 on the display 364.

In an example, a user 305 of the device 302 can be in possession of an object 308, such as being an owner of the object 308 or being a purchaser of the object 308. The object 308 can be, for example, a furniture, a parcel, a package, an equipment, and/or other types of objects that can be relatively large. The user 305 of the device 302 can demand a delivery or transportation of the object 308 from a first location 322 to a second location 324. In an example, the device 302 can be located in a location 320, where the location 320 can be same or different from the location 322 and/or the location 324. The user 305 of the device 302 can use the user interface 306 displayed on the display 304 to select a service provider to deliver or transport the object 308 from the location 322 to the location 324. In an example, the user interface 306 can display a plurality of service providers having a plurality of vehicles among a vehicle pool (e.g., pool 130 and 230 shown in FIGS. 1 and 2, respectively). The user 305 of the device 302 can select a service provider or a vehicle among the vehicle pool. In an example, a size of each vehicle among the vehicle pool can be displayed on the user interface 306 to allow the user 305 to select a vehicle based on a size of the vehicles in the vehicle pool. For example, the user 305 can select a vehicle that has sufficient capacity to store the object 308.

In an example, the vehicle pool can be maintained by the server 350 as a database (e.g., database 252 shown in FIG. 2). The database can be stored in a memory device of the server 350, and the database can include provider data, such as a plurality of attributes of a plurality of vehicles, such as their brand, model, make, model year, size category (e.g., compact, sedan, hatchback, minivan, van, pickup truck, truck, etc.). In some examples, the provider data can be presented in a map being displayed in the user interface 306 to show current locations of a plurality of available service providers. In an example, the device 302 can send a request 307 for a service provider or for a vehicle to the server 350. The server 350, in response to the receipt of the request 307, can extract a portion 354 of the database, where the portion 354 can include data on particular vehicles among the vehicle pool that satisfy one or more criteria specified by the request 307 (e.g., available times, vehicle size, etc.). For example, the request 307 can specify a time frame to fulfill the request 307, the location 322, and the location 324, and the portion 354 can include vehicles that are available in the specified time frame and located within a particular distance from the location 322. In some examples, the request 307 can include a size of the object 308 and/or an attribute of the vehicle being requested. For example, the request 307 can include a request for a vehicle of a particular size, brand, model, color, type, etc. The server 350 can send the portion 354 to the device 302.

In response to receiving the portion 354, the processor 310 can execute a part of the application 314 to output the portion 354 on the user interface 306. For example, the processor 310 can execute particular lines of executable code among the application 314 to populate a portion of the user interface 306 with the data of the portion 354, such that the data of the portion 354 can be viewable to the user 305 on the user interface 306. The user 305 of the device 302 can view the displayed portion 354 and can use the user interface 306 to input a selection 340. The device 302 can send the selection 340 to the server 150. The selection 340 can be a selection of a vehicle among a vehicle pool and among the portion 354. In the example shown in FIG. 3, the selection 340 can indicate a selection of a vehicle 334 among the vehicle pool.

In another example, the processor 310 of the device 302 can be configured to autonomously generate the request 307 in response to the application 314 being triggered by the device 302. For example, the user 305 can select the application 314 among a plurality of applications installed in the device 302. The processor 310 can detect the application 314 being selected and generate the request 307 to include at least a current location of the device 302 (e.g., location 320). The processor 310 can further append a message to the request 307 indicating that the request 307 is an autonomously generated request. The processor 310 can send the autonomously generated request 307 to the server 350. The server 350 can receive the autonomously generated request 307 and perform a prefetch (e.g., extraction of data before a user request) of the portion 354 from the database 352. The server 350 can store the extracted portion 354 in a memory of the server 350 until receiving another signal from the device 302 indicating a request for the extracted portion 354. For example, upon starting the application 314 on the device 302, the user 305 can input login credentials, and the processor 310 can generate a message or a new request in response to validating the login credentials. This message or new request can indicate that the user 305 has logged in to the application 314. The processor 310 can send this message or new request to the server 350. The server 350 can receive this message or new request and, in response, send the stored portion 354 to the device 302. By performing the prefetch of the portion 354, the system 300 can be implemented in a relatively efficient rate since the server 350 has the extracted portion 354 ready for transmission upon starting the application 314 on the device 302.

In another example, the user 305 can start the application 314 on the device 302, but exit or terminate the application 314 without inputting login credentials. The processor 310 can generate a message or a new request in response the application 314 being terminated, where this message or new request can indicate that the user 305 has exited the application 314 without logging in. The processor 310 can send this message or new request to the server 350. The server 350 can receive this message or new request and, in response, discard the stored portion 354.

In another example, the user 305 can start the application 314 on the device 302, but exit or terminate the application 314 without inputting login credentials. After a lapse of an amount of time (e.g., 30 seconds, 1 minute, 3 minutes, etc.), if the server 350 detects no further request from the device 302 indicating whether the user 305 has logged in or not, the server 350 can discard the stored portion 354.

In an example, in response to receiving the selection 340 from the device 302, the server 350 can communicate with the service provider that possess the selected vehicle 334 to fulfill the request 307. For example, in response to receiving the selection 340, the server 350 can identify a device identifier (e.g., stored in another database stored in memory devices of the server 350) that can be associated with a device 362, where the device 362 can be a user device possessed or operated by a user 330. The user 330 can be an owner or an operator who possess the selected vehicle 334. The device 362 can include a screen or a display 364. In an example, the display 364 can be a touch screen device configured to receive inputs from one or more users exerting pressure on the display 364. In some examples, the display 364 can be a display or screen coupled to the device 362 and the display 364 can be configured to receive inputs from input devices such as keyboard and computer mouse. In some examples, the display 364 can be a part of the device 362 (e.g., embedded in the device 362) or can be a separate component from the device 362. The device 362 can be configured to run an application to render and output a user interface 366 on the display 364.

In an example, the device 362 can include a processor 370 and a memory 372. The processor 370 can be configured to be in communication with the memory 372. The memory 372 can be a memory device among a plurality of memory devices embedded in the device 372 and/or the processor 370. The memory 372 can be configured to store the application 314, where the application 314 can be provided by the server 350. For example, the application 314 can be a mobile application and/or a computer application downloaded from the server 350 via the network 301. The application 314 can be an executable file and can include executable code that can be executed by the processor 310 according to an operating system being run by the processor 310 on the device 302. In an example, the server 350 can store the source code of the application 314. In an example, the execution of the application 314 can cause the user interface 366 to be rendered by the processor 310 and outputted by the processor 310 on the display 304. In an example, the application 314 can be installed on both the device 302 and the device 362, but the application 314 can be executed to render different user interfaces 306 and 366 on the displays 304 and 364, respectively, based on login information provided by different users. For example, the server 350 can verify that the login credentials of the user 305 belongs to a user group, and the server 350 can push graphical user interface (GUI) data to the device 302 to render the user interface 306. Similarly, the server 350 can verify that the login credentials of the user 330 belongs to a service provider group, and the server 350 can push graphics user interface (GUI) data to the device 362 to render the user interface 366.

The server 350 can generate selection data 356 indicating that the vehicle 334 is selected by a user (e.g., user 305 of the device processor 370) and send the selection data 356 to the device 362 through the network 301. The processor 370 of the device 362 can receive the selection data 356, and execute a portion (e.g., particular lines of code) of the application 314 to output a prompt on the user interface 366 to inquire whether the user 330 would accept or reject the request 307. The user 330 can use the user interface 366 to enter a response 358 that may include confirmation data indicating acceptance of rejection of the request 307. The response 358 can be transmitted to the server 350 as a message or data, though the network 301. In an example where the response 358 indicate a rejection, the server 350 can generate confirmation data 359 indicating that the user 330 of the selected vehicle 334 has rejected the request 307. The server 350 can send the confirmation data 359 to the device 302 though the network 301. In some examples, the confirmation data 359 can include instructions for the processor 310 to execute a portion of the application 314 to output the rejection on the user interface 306, and to output an input prompt asking the user 305 to select another vehicle or service provider.

In an example where the response 358 indicates an acceptance, the server 350 can generate the confirmation data 359 to indicate that the user 330 of the selected vehicle 334 has accepted the request 307. The server 350 can append various information and data to the confirmation data 359, such as contact information (e.g., phone number and e-mail address) of one or more of the user 305 and user 330, and/or a current location of the vehicle 334. The server 350 can send the confirmation data 359, with the appended information, to the device 302 though the network 301. The confirmation data 359 can include instructions for the processor 310 to execute a portion of the application 314 to output the acceptance on the user interface 306, and to output an input prompt asking the user 305 to confirm a time to fulfill the request 307. For example, the time frame indicated by the request 307 can be a time range of 1:00 PM to 1:30 PM, but upon receiving the confirmation data, the user 305 can use the device 302 to indicate a pickup time of 1:20 PM to pick up the object 308 from the location 322.

The user 305 can further use the user interface 306 to generate a command to start fulfillment of the request 307, and can use the device 302 to send the command to the server 350. Upon receiving the command, the server 350 can track real-time locations of the vehicle 334 until the vehicle 334 arrives at the location 322. The processor 310 of the device 302 can invoke a map application installed on the device 302 to render a map on the user interface 306. The device 302 can periodically pull the real-time locations of the vehicle 334 from the server 350 until the vehicle 334 arrives at the location 322, where the pulled real-time locations can be outputted or shown in the map. Further, in response to receiving the command from the device 302, the server 350 can initiate a payment process to facilitate payment from the user 305 to the user 330. In an example, the server 350 can communication with a third-party payment application or service through the network 301 to initiate the payment process. The server 350 can initiate the payment process by, for example, relaying user credentials of the users 305 and 330 from their respective devices to the third-party payment service. In some examples, the server 350 can be configured to execute encryption algorithms to encrypt the user credentials and prior to transmitting the user credentials to a third party device external to the system 300. In some examples, the server 350 may wait until a confirmation of fulfillment or completion of the request 307 from the device 302 and/or the device 362 before communicating with the third-party payment service to process payments from the user 305 to the user 330.

In an example embodiment, the processor 310 can execute a portion (e.g., particular section of executable code) of the application 314 to determine an expected arrival time of the selected vehicle 334 to arrive at the location 322. The expected arrival time can be based on a distance between the current location of the vehicle 334 and the location 322. Further, the processor 310 can estimate a time of arrival for the selected service provider during the tracking based on the pulled current location of the vehicle 334, and location 322, and traffic data that can be obtained from a traffic application or a map application installed on the device 302. The processor 310 can determine a difference between the expected arrival time and each estimated time of arrival periodically during the tracking of the real-time locations. In response to a determined difference being greater than a predefined threshold (e.g., defined by the application 314 or the user 305), the processor 310 can output a prompt on the user interface 302 to recommend cancellation of the request 307 due to the determined difference being greater than the predefined threshold indicating a longer expected time for the vehicle 334 to arrive at location 322.

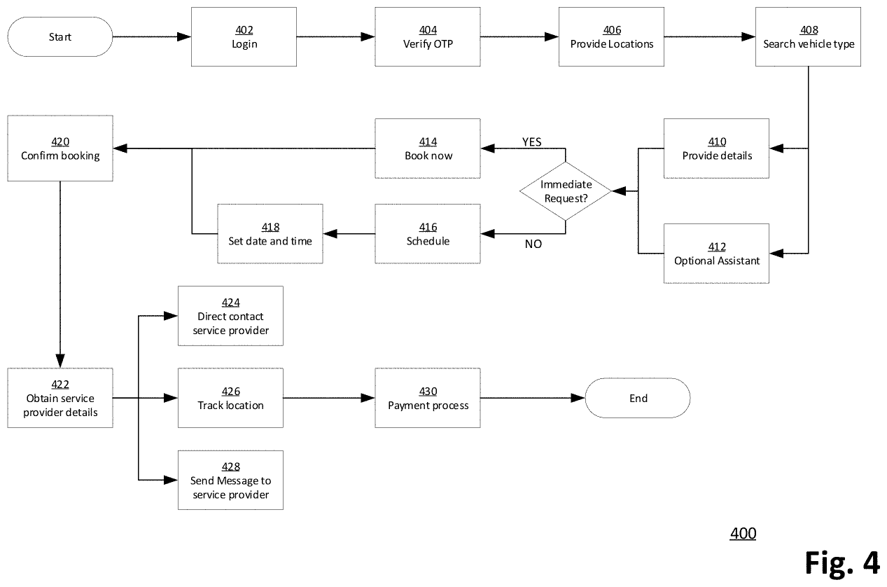

FIG. 4 is a diagram illustrating a process 400 that can implement on-demand transportation of objects in accordance with an embodiment of the present invention. The process in FIG. 4 may be implemented using, for example, systems 100, 200, and/or 300 discussed above. An example process may include one or more operations, actions, or functions as illustrated by one or more of blocks 402, 404, 406, 408, 410, 412, 414, 416, 418, 420, 422, 424, 426, 428, 430. Although illustrated as discrete blocks, various blocks may be divided into additional blocks, combined into fewer blocks, eliminated, or performed in parallel, depending on the desired implementation.

The process 400 can be implemented by the systems 100, 200, 300 shown in FIG. 1, FIG. 2, FIG. 3, respectively. The process 400 can start in response to a user device (e.g., device 102, 202, 302 in FIG. 1, FIG. 2, FIG. 3, respectively) executing an application (e.g., application 214, 314 in FIG. 2, FIG. 3, respectively). Upon starting the application, the process 400 can proceed to block 402. At block 402, a user can use the user device to perform a login process, such as entering user credentials including one or more of username, password, device authentication code, personal identification number, etc. In an example, if the user credentials entered at block 402 includes a one-time password (OTP), where the OTP can be provided to the user device by a server (e.g., server 150, 250, 350 in FIG. 1, FIG. 2, FIG. 3, respectively), the process 400 can proceed from block 402 to block 404. At block 404, the server can verify the OTP entered at block 402. If the OTP is verified by the server, the server can send a signal to the user device to notify the user device can continue with the application. If the OTP is not verified by the server, the server can send a signal to the user device to notify the user device that the OTP is not verified and the user cannot continue to use the application. The server can also require the user to use the user device to enter another OTP that may be provided by the server.

Upon verifying the OTP at block 404, the process 400 can proceed from block 404 to block 406. At block 406, the user can use the user device to request delivery of an object (e.g., object 108, 208, 308 in FIG. 1, FIG. 2, FIG. 3, respectively) from a starting location (e.g., location 122, 222, 322 in FIG. 1, FIG. 2, FIG. 3, respectively) to an ending location (e.g., location 124, 224, 324 in FIG. 1, FIG. 2, FIG. 3, respectively). The starting location can be a location to pick up the object that may need to be delivered to the ending location. In some examples, the object can be a relatively large or bulky object, such as one or more pieces of furniture or furniture components, boxes, parcels, equipment, appliances, electronics, etc. The process 400 can proceed from block 406 to block 408. At block 408, the user can use the user device to select a vehicle type that may be desired by the user to deliver the object. For example, the user can use the user device to select a vehicle having particular attributes, such as brand, model, size, storage capacity, etc. In some examples, the user can select a vehicle deemed as having sufficient storage space to store the object for delivery from the starting location to the ending location.

The process 400 can proceed from block 408 to block 410 and/or block 412. At block 410, the user can use the user device to provide any additional details relating to the delivery of the object from the starting location to the ending location. For example, the user can use the user device to provide details such as specific pick up time or a time frame to pick up the object, a specific address of the starting location, contact information of the user, details on the object being delivered (e.g., weight, contents in a box or parcel, type of object or furniture, etc.), etc. At block 412, the user can use the user device to input whether the user requires a helper or an assistant to assist in the delivery. For example, if the object is relatively heavy, the user can request one or more helpers to assist in the delivery. In some examples, the helpers can be selected by the service provider that was selected to fulfill the request.

If the request to deliver the object is an immediate request, the process 400 can proceed to block 414. If the request to deliver the object is not an immediate request, the process 400 can proceed to block 416. At block 414, the user can select a “book now” option that may be shown by a user interface displayed on the user device. At block 416, the user can select a “schedule” option that may be shown in the user interface. Upon selecting the “schedule” option at block 416, the process 400 can proceed to block 418, where the user can set a future date and time for the selected service provider or vehicle to fulfill the request. The process 400 can proceed from block 414 or block 418 to block 420. At block 420, the user can use the user device to confirm the booking or selection of the vehicle, the date and time for the selected vehicle to fulfill the request, and/or other details entered using the user device.

The process 400 can proceed from block 420 to block 422. At block 422, the user device can receive or obtain service provider details relating to the selected vehicle from the server. The obtained service provider details can include the selected vehicle's brand, model, make year, plate number, operator information such as driver license number, picture, contact information, etc. The process 400 can proceed from block 422 to one or more blocks 424, 426, 428. At block 424, the user can use the user device to directly contact the service provider. For example, an option to call the service provider can appear on the user interface, and if the user selects this call option, the user device can execute a phone application to facilitate the call to the service provider. At block 428, the user can use the user device to directly message the service provider. For example, an option to text message the service provider can appear on the user interface, and if the user selects this call option, the user device can execute a text message application to facilitate the call to the service provider. Note that other applications can be executed by the user device to contact the service provider, such as social media applications, instant messaging applications, e-mail applications, etc. At block 426, the server 350 can begin to track a location of the service provider. The locations tracked by the server 350 can be pulled by the user device periodically. The process 400 can proceed from block 426 to block 430. At block 430, the server 350 can wait for a confirmation on whether the request (or the delivery of the item) is fulfilled or completed. The confirmation on whether the request is fulfilled or not can be provided to the server by the user device and/or the service provider. In response to a fulfillment of the request, the server can initial a payment process to facilitate the user of the user device (or the user who made the request) paying the service provider.

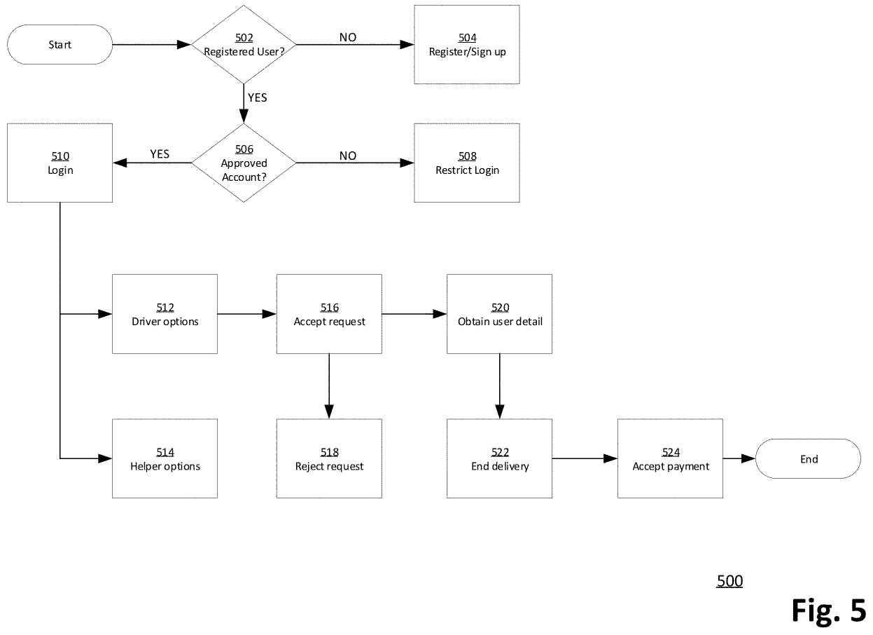

FIG. 5 is a diagram illustrating another process 500 that can implement on-demand transportation of objects in accordance with an embodiment of the present invention. The process in FIG. 5 may be implemented using, for example, systems 100, 200, and/or 300 discussed above. An example process may include one or more operations, actions, or functions as illustrated by one or more of blocks 502, 504, 506, 508, 510, 512, 514, 516, 518, 520, 522, and/or 524. Although illustrated as discrete blocks, various blocks may be divided into additional blocks, combined into fewer blocks, eliminated, or performed in parallel, depending on the desired implementation.

The process 500 can be implemented by the systems 100, 200, 300 shown in FIG. 1, FIG. 2, FIG. 3, respectively. The process 500 can start in response to a provider device (e.g., device 362 in FIG. 3) executing an application (e.g., application 314 in FIG. 3). Upon starting the application, the process 500 can proceed to block 502. At block 502, the application being executed by the provider device can display an inquiry window to inquire whether a provider (e.g., a user operating the provider device) using the provider device is a registered user or not. If the provider is not a registered user, the process 500 can proceed to block 504. If the provider is a registered user, the process 500 can proceed to block 506. At block 504, the provider device can execute a registration or sign up process to obtain user credentials from the provider, such as username, password, contact information of the provider, vehicle registration of one or more of the provider's vehicles, vehicle identification number (VIN) of one or more of the provider's vehicles, the provider's driver license information, etc. In some examples, the provider may use the provider device to submit driver license information to a server, and the server can communicate with another server of an official entity, such as the department of motor vehicles, to obtain driving history of the provider. In another example, the provider may use the provider device to submit the provider's information to the server, and the server can communicate with another server of a law enforcement entity to determine whether the provider has any malicious criminal records. The server can obtain a binary response from the law enforcement, such as “yes” or “no”, such that the privacy of the provider can be preserved. Upon obtaining various user credentials and information, the server can facilitate registration of the provider into a provider database.

At block 506, in response to the provider being a registered user, the server can determine whether the provider's account is an approved account or not. In some examples, the provider's account may not be an approved account due to, for example, unsatisfactory behavior such as damaging objects being delivered, not being on time, rude behavior, making mistakes on delivery requests, etc. In response to an identification of unsatisfactory behavior, the process 500 can proceed to block 508, where the server can restrict the login attempt by the provider. In response to an absence of unsatisfactory behavior, the process 500 can proceed to block 510, where the server can complete the login attempt by the provider.

The process 500 can proceed from block 510 to blocks 512 and/or 514. At block 512, the provider can use the provider device to view various options on provided by the server and the application. For example, the driver can be presented with an option on a user interface to edit his or her driver profile, contact information, vehicle information, etc. In another example, the provider can be presented with options to view historical deliveries, available delivery requests within an area of a current location of the provider, etc. At block 514, the provider can be presented with options to view available helpers or assistants that may be available to accompany the provider to fulfill a delivery request. Further, at block 512, the provider can be presented with a notification that the provider's vehicle has been selected for a delivery request. If the provider accepts the request, the process 500 can proceed to block 516. If the provider rejects the request, the process 500 can proceed to block 518. At block 518, the provider can reject the request and the server can notify the user who selected the provider's vehicle that the request has been rejected.

At block 516, the provider device can notify the server that the request has been accepted. The process 500 can proceed to block 520. At block 520, the server can provide details of the user who placed the request to the provider device. The provider device can also allow the server to begin tracking the provider device's locations to facilitate fulfillment of the delivery request. Upon a completion of the delivery, the process 500 can proceed to block 522, where the provider device can send a notification to the server to indicate an end of delivery. The process 500 can proceed to block 524, where the provider device can accept payment from the user who placed the delivery request.

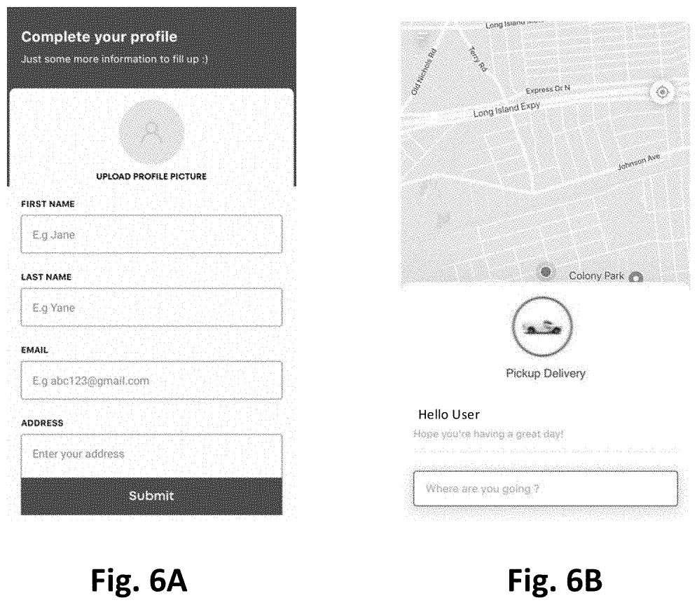

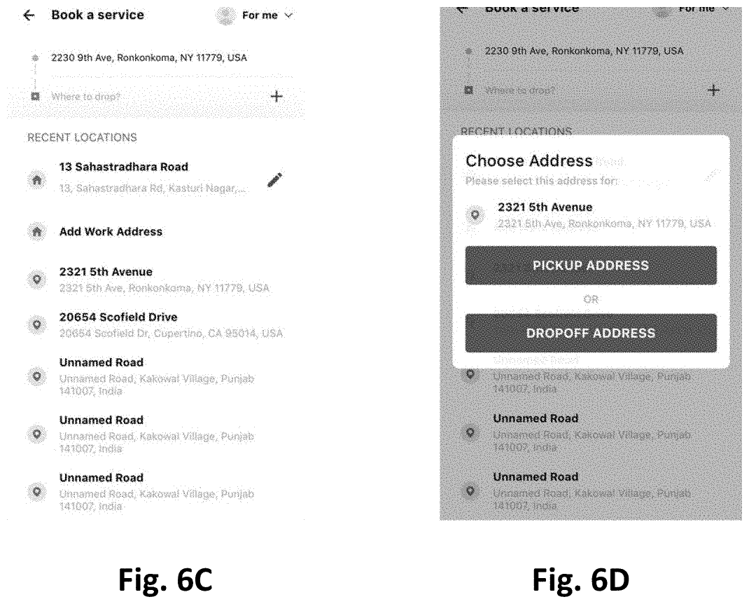

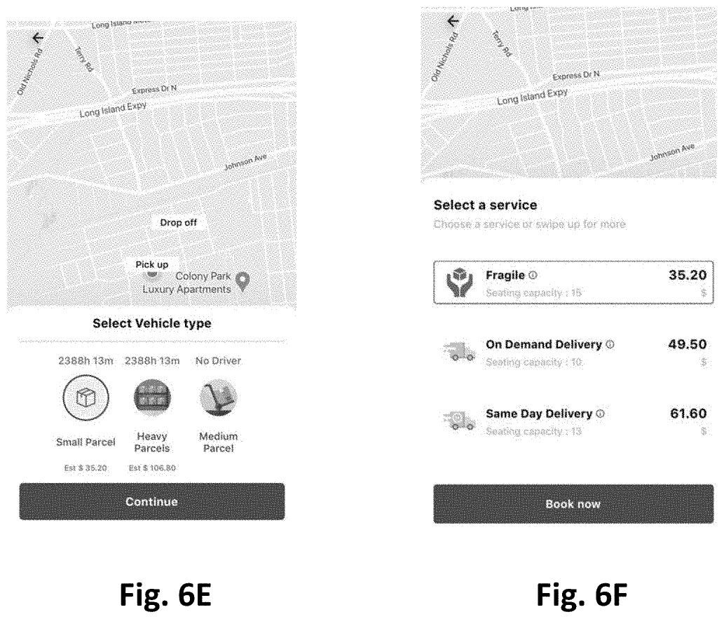

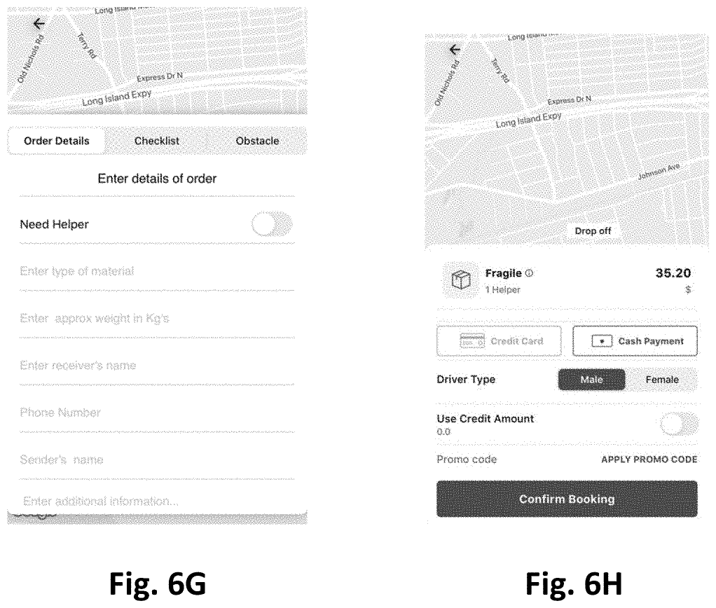

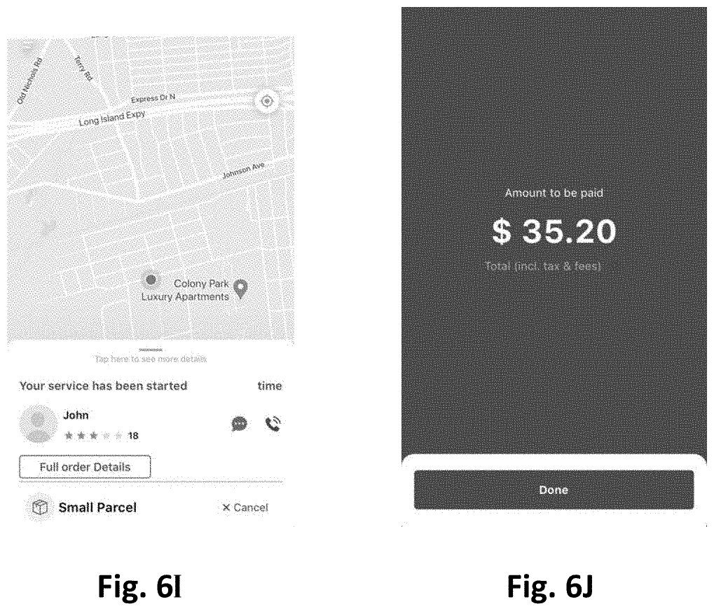

FIGS. 6A-6J are diagrams illustrating operations of a user interface that can be used to implement on-demand transportation of objects in one embodiment. The user interface shown in FIG. 6A-6H can be displayed in the user interfaces 102, 202, and 302 of FIGS. 1, 2, 3, respectively. FIG. 6A shows an example window of the user interface that can allow a user (e.g., user 105, 205, 305 in FIGS. 1, 2, 3, respectively) to enter user information to complete a user profile. The user profile can be accessed by an application (e.g., application 114, 214, 314 in FIGS. 1, 2, 3, respectively) to facilitate fulfillment of delivery requests as described herein. For example, the application can pull information from the user profile to be shared with a service provider that is selected to fulfill a request by a user having this user profile.

FIG. 6B shows an example window that can be outputted in the user interface in response to a successful login from the user, where this example window can include a text input field. The user can enter a starting location in the text input field to input a pickup location of an object (e.g., object 108, 208, 308 in FIGS. 1, 2, 3, respectively) to be delivered to a destination location. The user can enter a full address, street intersection, zip code, etc., that can be processed by a device running the application and the user interface to determine the starting location. FIG. 6C shows an example window that can be outputted in the user interface in response to the user entering a start location. The window in FIG. 6C shows the user interface displaying another text input field for the user to enter the destination address. Further, the window in FIG. 6C also shows a list of recently used locations that have been entered by the user previously. FIG. 6D shows an example window that can be outputted in the user interface in response to the user entering a location in the text input fields of FIG. 6B or FIG. 6C. The window shown in FIG. 6D includes a pop-up window inquiring the user whether the entered location is a pickup address (starting location) or a drop-off address (destination address).

FIG. 6E shows an example window that can be outputted in the user interface in response to the user confirming the pickup and drop-off locations. The window shown in FIG. 6E includes a map that shows the confirmed pickup and drop-off locations. Further, the window shown in FIG. 6E allows to the user to select various options relating to the object being delivered. For example, the user can select small parcel, heavy parcel, or medium parcel, to indicate the size and type of the object being requested to be delivered. The window shown in FIG. 6E can also display expected time for the delivery request to be fulfilled, and estimated costs to deliver the object based on the object's size. The user can select the “Continue” option to continue the delivery request process. FIG. 6F shows an example window that can be outputted in the user interface to allow the user to select various delivery options having different costs. For example, the user can select a “Fragile” option to request a drive or service provide to handle the object with extra care. The user can select “On Demand Delivery” to request delivery in a relatively late future time, such as from the next day and on. The user can select “Same Day Delivery” to request delivery on the same day. Further, in another embodiment, the window can include a “Bring it Now” option. The user can select the “Bring it Now” to request delivery immediately. By “immediately” is generally less than about 3 hours, preferably less than about 2 hours, more preferably less than about 1 hour and even more preferably less than about 30 minutes. In some embodiments, the immediate delivery request corresponding to the “Bring it Now” option can cause the user's device to immediately communicate with the server, and the server can select a service provider (instead of having the user select the provider) for the user instantaneously. For example, the server can identify a service provider that can fulfill the delivery request within a shortest time when compared to other service providers. In an example, the server can be configured to identify a service provider that is geographically closest to a pickup location of the object to fulfill an immediate delivery as requested by the “Bring it Now” option. In another example, the server can be configured to identify service providers that are located with a geographical radius of the pickup location of the object, and can obtain traffic information within the geographical radius. The traffic information can include, for example, traffic congestion levels, amount of highways or freeways and local roads, current construction, within the geographical radius. The server can use the obtain traffic information function to identify a service provider, among the plurality of service providers within the geographical radius, that can perform the pickup of the object at an earliest time to fulfill an immediate delivery request as requested by the “Bring it Now” option. By way of example, a first service provider can be located at a shorter distance from the pickup location when compared to a second service provider. However, the second service provider may be able to arrive at the pickup location earlier than the first service provider due to various traffic conditions indicated by the obtained traffic information. Thus, the server can select the second service provider to fulfill an immediate delivery request as requested by the “Bring it Now” option. The window in FIG. 6E can also display an estimated cost associated with each option. Further, more than one selection can be made by the user, such as “Fragile”, “Same Day Delivery” and “Bring it Now”. Upon selecting more than one option, the device executing the application can sum the estimated costs for the more than one selected options.

FIG. 6G shows an example window that can be outputted in the user interface to allow the user to enter various details of the delivery request. For example, the user can indicate whether a helper is needed, enter the type of material of the object, enter a weight of the object, enter a recipient's name (recipient of the object), phone number of the user, a sender's name (could be the user, or another sender), and any additional information (e.g., upload one or more pictures of the object to be delivered) relating to the delivery request. Further, in the example window shown in FIG. 6G, an “Obstacle” tab can be selected by the user to indicate whether the delivery (at both pick-up location and drop-off location) may include obstacles such as stairs (and how many flights), elevators, escalators, doorman sign-in and approvals, slopes (uphill or downhill), etc. FIG. 6H shows an example window that can be outputted in the user interface to allow the user to enter additional details before confirming booking for the delivery request. For example, the user can indicate whether he or she would like to pay by credit card or cash. Further, the user can select a driver type, such as a gender. The user can further enter promotional code that may provide discount for the user. Further, the user may have credits with the application, and can use the user interface to view any remaining balance. The user can select the “Confirm Booking” option to select a vehicle or service provider to fulfill the delivery request.

FIG. 6I shows an example window that can be outputted in the user interface in response to the user confirming booking in the window shown in FIG. 6H. The window shown in FIG. 6I can include an indication that a fulfillment of the delivery request has started. The user can also see information relating to the delivery request and the service provider details in this window. This window can also include various icons to contact the service provider, such as a call button or a message button. Further, a map can be shown in this window such that the user can view a current location of the service provider to track the location of the service provider. FIG. 6J shows an example window that can be outputted in the user interface in response to a completion of the delivery request. The user can be presented with an amount that needs to be paid to the service provider that has completed the delivery request.

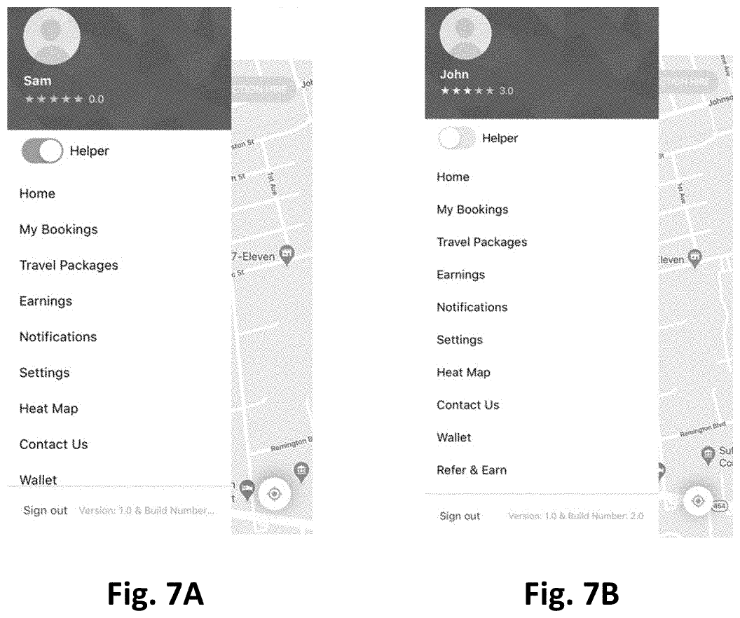

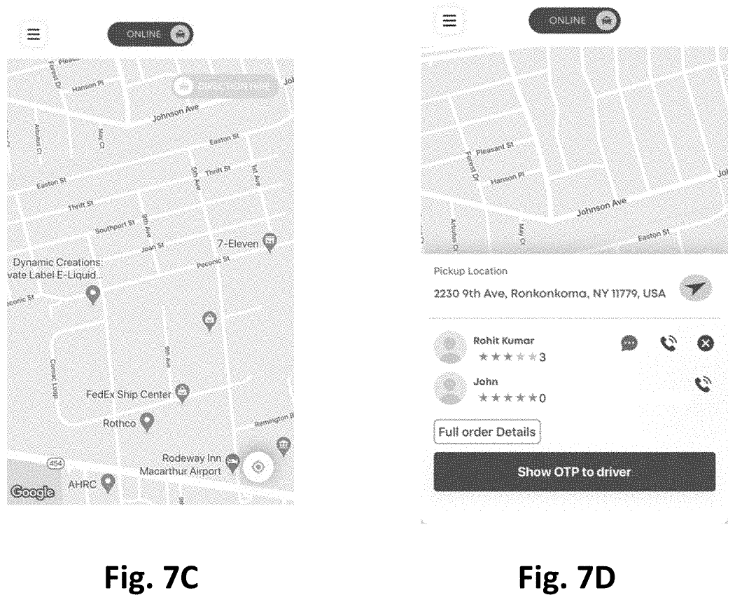

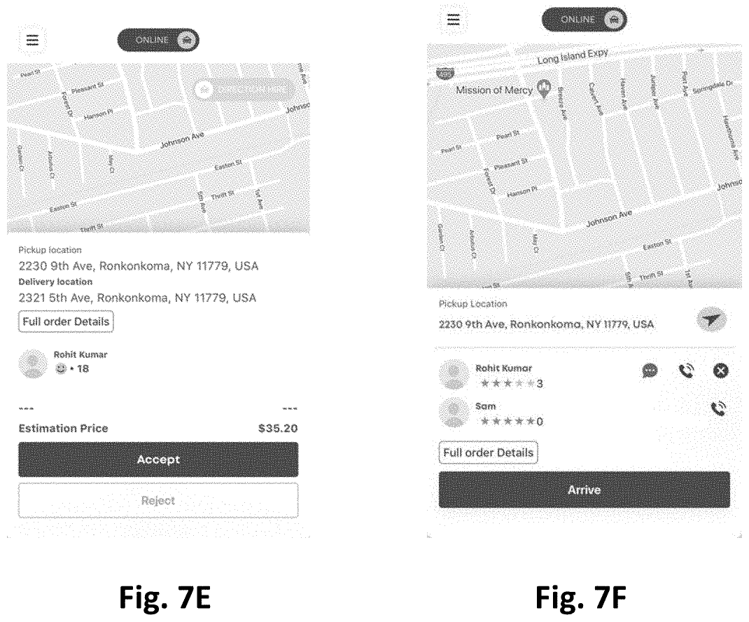

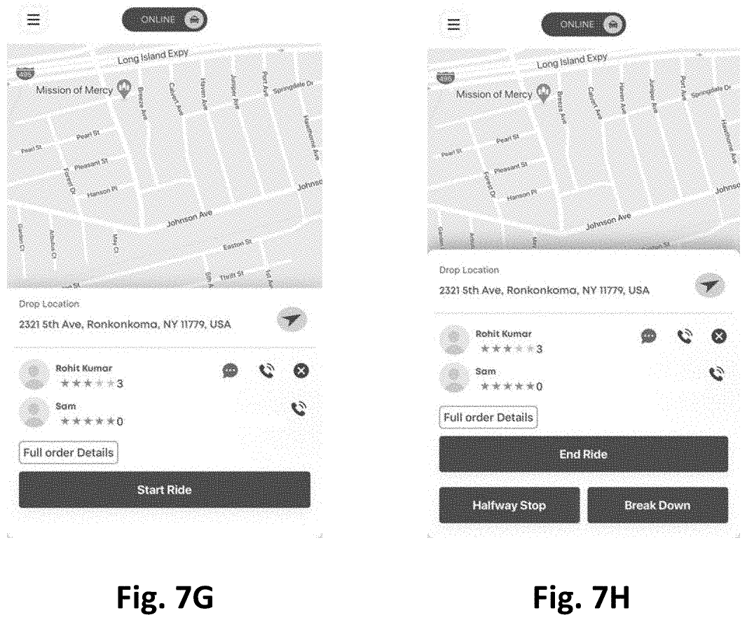

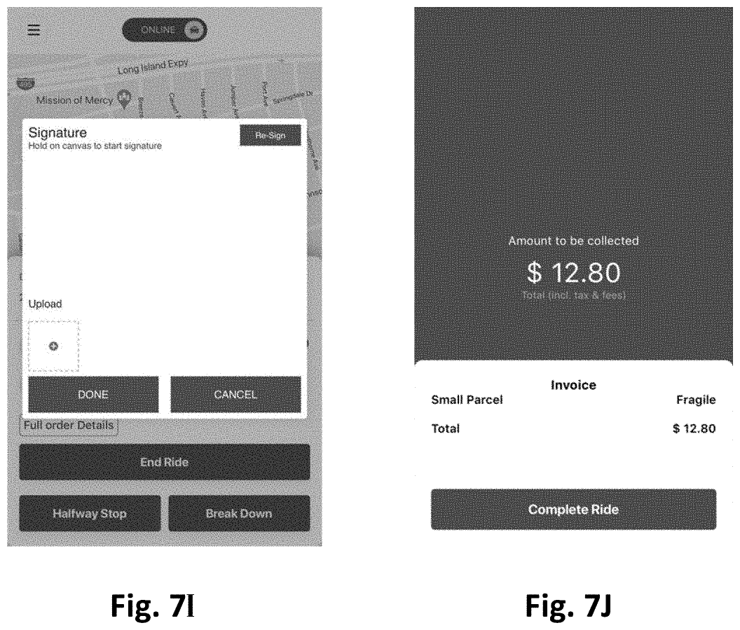

FIGS. 7A-7J are diagrams illustrating operations of another user interface that can be used to implement on-demand transportation of objects in one embodiment. The user interface shown in FIG. 7A-7H can be displayed in the user interface 366 of FIG. 3. FIG. 7A shows a window being displayed in the user interface in response to a provider (e.g., user 330 in FIG. 3) successfully logged in to an application (e.g., application 374 in FIG. 3) being executed by a provider device (e.g., device 362 in FIG. 3). The window shown in FIG. 7A can include various options for the provider, such as viewing a current review score of the provider, viewing a list of current and historical bookings (fulfilled and/or unfulfilled), earnings, notifications, settings, maps, etc. The window in FIG. 7A can also allow the provider to select whether to view a list of available helpers or not. For example, the window in FIG. 7A has the “Helper” toggle selected, which indicates that the provider would like to have helpers to assist deliveries. In an example in FIG. 7B, the “Helper” toggle is turned off, indicating that the provider does not need assistance from a helper.

FIG. 7C shows a window being displayed in the user interface in response to the provider selecting to see a map to look for available requests. The provider can browse the map to see if there are available delivery requests. FIG. 7D shows a window being displayed in the user interface in response to the provider device receiving a delivery request. The window shown in FIG. 7D can include a pickup location, the user that made the delivery request, and other information relating to the delivery request received by the provider device. FIG. 7E shows a window being displayed in the user interface in response to the provider selecting a “Full Order Detail” button in FIG. 7D. In the window shown in FIG. 7E, the full order details can show the pickup location and the destination location, the user that made the delivery request, an estimated price, etc. The provider can accept or reject the delivery request using the window shown in FIG. 7E.

FIG. 7F shows a window being displayed in the user interface in response to the provider accepting the delivery request in FIG. 7E. The window in FIG. 7F shows a map, and details of the delivery order, and an “Arrive” option. Once the provider arrives at the pickup location, the provider can select the “Arrive” option, where selecting the “Arrive” option will cause the provider device to automatically contact the user who made the delivery request that the provider has arrived at the pickup location. The automatic contact can include calling, test messaging, pushing a notification by the application, social media, etc. FIG. 7G shows a window being displayed in the user interface in response to the provider selecting the “Arrive” option in FIG. 7F. The window in FIG. 7G shows a map, and details of the delivery order, and a “Start Ride” option. Once the provider begins the trip to deliver the object from the pickup location to the destination location, the provider can select the “Start Ride” option, where selecting the “Start Ride” option will cause the provider device to automatically contact the user who made the delivery request that the trip to deliver the object has started. The automatic contact can include calling, test messaging, pushing a notification by the application, social media, etc.

FIG. 7H shows a window being displayed in the user interface in response to the provider selecting the “Start Ride” option in FIG. 7G. The window in FIG. 7H shows a map, and details of the delivery order, and various options for the provider to notify the user of any incidents during the trip. For example, the provider can select a “Halfway Stop” option to automatically contact the user that the provider is taking a break. The provider can also select a “Break Down” option if the providers vehicle break down to automatically contact the user that there is an incident that may prevent the delivery from arriving on time. Once the provider arrives at the destination, the provider can select the “End Ride” option to automatically contact the user who made the delivery request that the provider has arrived at the destination location and the object has been delivered. The automatic contact can include calling, test messaging, pushing a notification by the application, social media, etc.

FIG. 7I shows a window being displayed in the user interface in response to the provider selecting the “End Ride” option in FIG. 7H. A pop-up window can appear on the user interface, where the pop-up window can include a touch screen input field for the user who made the delivery request (if the user is physically accompanying the provider), or a recipient of the object, at the destination location to provide a signature. Further, the pop-up window can include an “Upload” option for the provider to take a picture of the object being received by the recipient, or the object being placed at the destination location, and upload the picture to be stored in the provider device and/or the server. The signature and/or the picture can serve as proof that the delivery is successfully completed. The provider can select the “Done” option to signal the complete delivery. FIG. 7J shows a window being displayed in the user interface in response to the provider selecting the “Done” option in FIG. 7I. The window in FIG. 7J shows cost that shall be received by the provider in response to completing the delivery, and an invoice of the delivery. Further, the provider can select the “Complete Ride” option to notify the server that the delivery is completed, such that the server can facilitate a payment process to allow the user to pay the provider the amount indicated in the window of FIG. 7J.

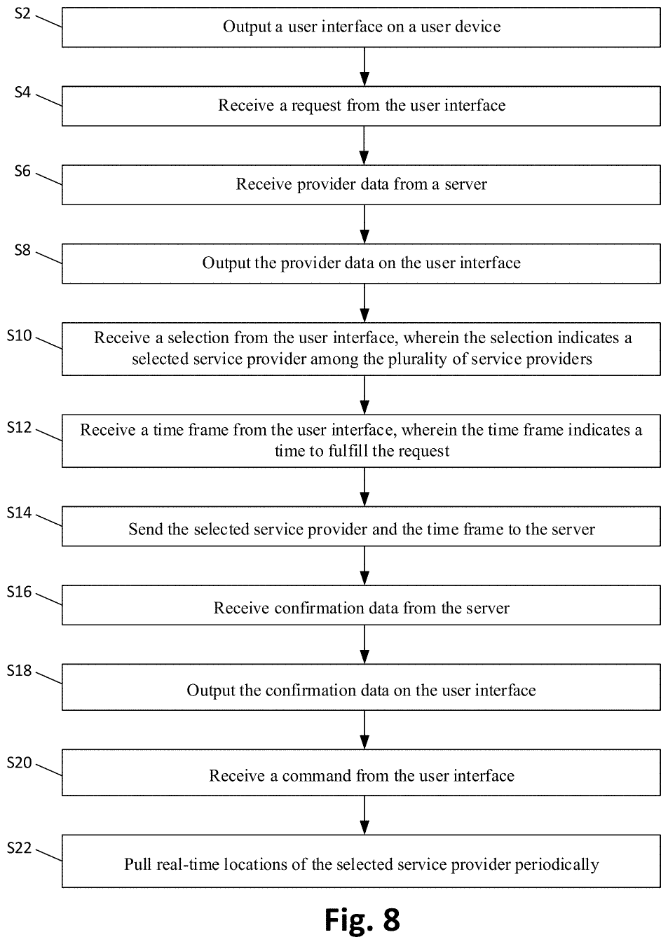

FIG. 8 is a diagram illustrating another process that can implement on-demand transportation of objects in one embodiment. The process in FIG. 8 may be implemented using, for example, systems 100, 200, and/or 300 discussed above. An example process may include one or more operations, actions, or functions as illustrated by one or more of blocks S2, S4, S6, S8, S10, S12, S14, S16, S18, S20, and/or S22. Although illustrated as discrete blocks, various blocks may be divided into additional blocks, combined into fewer blocks, eliminated, or performed in parallel, depending on the desired implementation.

The process can begin at block S2, where a processor can output a user interface on a user device. The process can continue from block S2 to S4, where the processor can receive a request from the user interface. The request can be a request for delivering an object from a first location to a second location, and the request includes at least one requested attribute of a vehicle. The process can continue from block S4 to S6, where the processor can receive provider data from a server. The provider data can include information of a plurality of service providers that are able to provide a vehicle having the requested attribute. The process can continue from block S6 to S8, where the processor can output the provider data on the user interface.

The process can continue from block S8 to S10, where the processor can receive a selection from the user interface. The selection can indicate a selected service provider among the plurality of service providers. The process can continue from block S10 to S12, where the processor can receive a time frame from the user interface, wherein the time frame indicates a time to fulfill the request. The process can continue from block S12 to S14, where the processor can send the selected service provider and the time frame to the server. The process can continue from block S14 to S16, where the processor can receive confirmation data from the server. The confirmation data can indicate an acceptance from the selected service provider, and a current location of the selected service provider.

The process can continue from block S16 to S18, where the processor can output the confirmation data on the user interface. The process can continue from block S18 to S20, where the processor can receive a command from the user interface. The command can be a command for starting a fulfillment of the request. The process can continue from block S20 to S22, where the processor can, in response to receiving the command, pull real-time locations of the selected service provider periodically until the selected service provider is located at the first location.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for identifying at least one service provider, the method comprising:
outputting, by a processor, a user interface on a user device;
receiving, by the processor, a request from the user interface, wherein the request is for delivering an object from a first location to a second location, and the request includes at least one requested attribute of a vehicle;
receiving, by the processor, a time frame from the user interface, wherein the time frame indicates a time to fulfill the request;
sending, by the processor, the first location, the second location, the at least one requested attribute of the vehicle, and the time frame to a server to request the server to extract data from a database stored in the server that corresponds to the at least one requested attribute of the vehicle;
receiving, by the processor, confirmation data from the server, wherein the confirmation data indicates an acceptance from a service provider to fulfill the request, and a current location of the service provider;
outputting, by the processor, the confirmation data on the user interface;
receiving, by the processor, a command from the user interface to start a fulfillment of the request; and
in response to receiving the command, pulling, by the processor, real-time locations of the service provider periodically from the server until the service provider is located at the first location.

2. The method of claim 1, wherein the at least one requested attribute of the vehicle comprises a size of the vehicle.

3. The method of claim 1, wherein the request further includes a request for an assistant provider, and obtaining the confirmation data further comprises obtaining assistant provider data that includes information of one or more assistant providers.

4. The method of claim 1, wherein the time frame indicates a need to fulfill the request immediately.

5. The method of claim 1, wherein the time frame indicates a future time frame.

6. The method of claim 1, wherein in response to receiving the command:
invoking, by the processor, a map application installed on the user device; and
outputting, by the processor, a current location of the service provider on a map rendered by the map application.

7. (canceled)

8. The method of claim 1, further comprising:
determining, by the processor, an expected arrival time of the service provider to arrive at the first location;
estimating, by the processor, a time of arrival for the service provider during the pulling of the real-time locations;
determining, by the processor, a difference between the expected arrival time and the estimated time of arrival periodically during the pulling of the real-time locations; and
in response to the difference between the expected arrival time and the estimated time of arrival being greater than a predefined threshold, outputting, by the processor, a prompt on the user interface to recommend cancellation of the request.

9. A system for identifying at least one service provider, the system comprising:
a server configured to store a database that includes provider data, wherein the provider data includes information of a plurality of service providers;
a processor configured to be in communication with the server, the processor being configured to:
output a user interface on a user device;
receive a request from the user interface, wherein the request is for delivering an object from a first location to a second location, and the request includes at least one requested attribute of a vehicle;
receive a time frame from the user interface, wherein the time frame indicates a time to fulfill the request;
send the first location, the second location, the at least one requested attribute of the vehicle, and the time frame to the server to request the server to extract data from a database stored in the server that corresponds to the at least one requested attribute of the vehicle;
receive confirmation data from the server, wherein the confirmation data indicates an acceptance from a service provider to fulfill the request, and a current location of the service provider;
output the confirmation data on the user interface;
receive a command from the user interface to start a fulfillment of the request; and
in response to receiving the command, pull real-time locations of the service provider from the server periodically until the service provider is located at the first location.

10. The system of claim 9, wherein the at least one requested attribute of the vehicle comprises a size of the vehicle.

11. The system of claim 9, wherein the request further includes a request for an assistant provider, and obtaining the confirmation data further comprises obtaining assistant provider data that includes information of one or more assistant providers.

12. The system of claim 9, wherein the time frame indicates one of:
a need to fulfill the request immediately; and
a future time frame.

13. The system of claim 9, wherein the processor is further configured to:
invoke a map application installed on a device displaying the user interface; and
output a current location of the service provider on a map rendered by the map application.

14. The system of claim 9, wherein the processor is further configured to:
determine an expected arrival time of the service provider to arrive at the first location;
estimate a time of arrival for the service provider during the pulling of the real-time locations;
determine a difference between the expected arrival time and the estimated time of arrival periodically during the pulling of the real-time locations; and
in response to the difference between the expected arrival time and the estimated time of arrival being greater than a predefined threshold, output a prompt on the user interface to recommend cancellation of the request.

15. The system of claim 9, wherein the processor is a first processor, and the system further comprises a second processor configured to:
receive the request and the time frame from the server;
send a response to the server, wherein the response indicates the acceptance of the request;
send the current location of the service provider to the server;
receive an indication from the server, wherein the indication indicates the command to start the fulfillment is received at the server; and
push the real-time locations of the service provider to the server periodically to facilitate the tracking of the real-time locations by the first processor.

16. A device for identifying a service provider, the device comprising:
a memory configured to store instructions;
a processor configured to execute the instructions stored in the memory to:
output a user interface on a user device;
receive a request from the user interface, wherein the request is for delivering an object from a first location to a second location, and the request includes at least one requested attribute of a vehicle;
receive a time frame from the user interface, wherein the time frame indicates a time to fulfill the request;
send the first location, the second location, the at least one requested attribute of the vehicle, and the time frame to a server to request the server to extract data from a database stored in the server that corresponds to the at least one requested attribute of the vehicle;
receive confirmation data from the server, wherein the confirmation data indicates an acceptance from a service provider to fulfill the request, and a current location of the service provider;
output the confirmation data on the user interface;
receive a command from the user interface to start a fulfillment of the request; and
in response to receiving the command, pull real-time locations of the service provider from the server periodically until the service provider is located at the first location.

17. The device of claim 16, wherein the at least one requested attribute of the vehicle comprises a size of the vehicle.

18. The device of claim 16, wherein the request further includes a request for an assistant provider, and obtaining the confirmation data further comprises obtaining assistant provider data that includes information of one or more assistant providers.

19. The device of claim 16, wherein the time frame indicates one of:
a need to fulfill the request immediately; and
a future time frame.

20. The device of claim 16, wherein the processor is configured to execute the instructions stored in the memory to:
determine an expected arrival time of the service provider to arrive at the first location; estimate a time of arrival for the service provider during the pulling of the real-time locations;
determine a difference between the expected arrival time and the estimated time of arrival periodically during the pulling of the real-time locations; and
in response to the difference between the expected arrival time and the estimated time of arrival being greater than a predefined threshold, output a prompt on the user interface to recommend cancellation of the request.

21. The method of claim 1, wherein:
in response to the time frame indicating a need to fulfill the request immediately, the service provider being indicated in the confirmation data being received from the server is selected by the server from among the data extracted from the database; and
in response to the time frame being future time frame, prior to receiving the confirmation data from the server, the method further comprising:
receiving, by the processor, the data extracted from the server, wherein the data extracted from the server includes a pool of service providers;
populate, by the processor, the pool of service providers on the user interface;
receiving, by the processor, a selection from the user interface, the selection being a selection of the service provider from the pool of service providers; and
sending, by the processor, the selection to the server, wherein the confirmation data indicates the service provider.
